(19) United States
(12) Patent Application Publication
(10) Pub. No.: US 2026/0223893 A1
(43) Pub. Date: Aug. 6, 2026

(54) MULTIVITAMIN FORMULATION

(71) Applicant: ELLAOLA BRANDS INC., New York, NY (US)

(72) Inventors: Holly Pan, Forest Hills, NY (US); Luke Li, Forest Hills, NY (US)

(73) Assignee: ELLAOLA BRANDS INC., New York, NY (US)

(21) Appl. No.: 19/576,595

(22) Filed: Mar. 24, 2026

Related U.S. Application Data
(60) Provisional application No. 63/780,021, filed on Mar. 28, 2025.

(51) Int. Cl. A23L 2/39; A23L 2/60; A23L 19/00; A23L 19/10; A23L 33/00; A23L 33/15; A23L 33/16

(52) U.S. Cl. CPC A23L 2/39; A23L 2/60; A23L 19/01; A23L 19/11; A23L 33/15; A23L 33/16; A23L 33/40

(57) ABSTRACT

A powdered beverage composition formulated as a balanced combination of vitamins, minerals, fruits, vegetables, and other nutritional components configured to deliver high volumes of nutrients without altering the taste, color, or smell of the consumable medium. The powdered beverage composition is substantially flavorless, odorless, and colorless when dissolved in a beverage or soft food product. The composition can be formulated to be age appropriate, such as for toddlers or other children, or for adults. Such formulation is designed to provide enhanced nutritional supplementation in a manner that is easily incorporated into everyday dietary routines. Also, a method of manufacturing the powdered beverage composition.

### CROSS-REFERENCE TO RELATED APPLICATIONS

This application claims the benefit of U.S. Provisional Application No. 63/780,021, filed on Mar. 28, 2025, the entire disclosure of which is hereby incorporated by reference.

### BACKGROUND

Nutritional supplementation plays a role in supporting the dietary intake of individuals across various age groups. Children, in particular, may have dietary patterns that do not consistently provide all vitamins, minerals, and other nutrients that contribute to their nutritional intake. Parents and caregivers may seek to supplement the diets of children to address potential gaps in nutrient consumption. Adults may similarly seek nutritional supplementation to complement their dietary intake.

Supplements are available in various forms, including tablets, capsules, chewable tablets, gummies, and powders. Powdered supplements may be dissolved in water or other liquids, or mixed into soft foods, for consumption. Powdered supplements offer flexibility in administration, as they may be incorporated into beverages or foods that the intended consumer already consumes.

However, powdered supplements present challenges related to taste, appearance, and texture. Many vitamins and minerals have inherent taste characteristics, including metallic or bitter notes, that may be perceptible when the supplement is dissolved in a liquid. Vitamin A, for example, is associated with a metallic taste. Additionally, certain vitamins and minerals may impart color to a liquid when dissolved. Vitamin A may impart a yellow color to water. These taste and color characteristics may reduce the willingness of consumers, particularly children, to consume the supplemented beverage.

Texture presents another challenge for powdered supplements. When a powdered supplement is added to a liquid, the powder may not dissolve completely, leaving particulates that impart a gritty or sandy texture to the beverage. This texture may be unappetizing and may further reduce consumer acceptance of the supplemented beverage.

The solubility of a powdered supplement in a liquid is constrained by the solubility limit of the liquid. The solubility limit represents the maximum amount of solute that can dissolve in a solvent at a given temperature and pressure. When the amount of powdered supplement exceeds the solubility limit of the liquid, undissolved particulates may remain in the beverage. Beverages intended for children tend to have smaller volumes than beverages intended for adults, which means that the total amount of powdered supplement that can be dissolved in a child-sized beverage is correspondingly limited.

Formulating a powdered supplement that delivers desired amounts of vitamins, minerals, and other nutrients while remaining within the solubility limit of a small-volume beverage presents formulation challenges. Reducing the amounts of vitamins and minerals in the supplement to improve solubility may result in a supplement that does not deliver the intended nutritional benefit. Conversely, including higher amounts of vitamins and minerals may result in incomplete dissolution and the associated taste, appearance, and texture issues described above.

Manufacturing powdered supplements with fine particle sizes may improve dissolution characteristics but may introduce manufacturing challenges. Fine powders may exhibit reduced flowability compared to granular materials, may adhere to manufacturing equipment, and may disperse during manufacturing processes.

### SUMMARY

According to an exemplary embodiment, a powdered beverage composition may be provided. The powdered beverage composition may comprise a vitamin component comprising one or more vitamins selected from the group consisting of vitamin A, vitamin B1, vitamin B3, vitamin B5, vitamin B6, vitamin B7, vitamin B9, vitamin B12, vitamin C, vitamin D, vitamin E, and vitamin K2. The powdered beverage composition may comprise a mineral component comprising one or more minerals selected from the group consisting of iodine, zinc, selenium, manganese, calcium carbonate, choline bitartrate, and magnesium citrate. The powdered beverage composition may comprise a fruit and vegetable component comprising one or more of blueberry, strawberry, acerola cherry extract, tomato, apple, cauliflower, elderberry, broccoli, cabbage, carrot, kale, parsley, raspberry, spinach, and shiitake mushroom. The powdered beverage composition may comprise a sweetening component comprising monk fruit.

According to another exemplary embodiment, a method of manufacturing a powdered beverage composition may be provided. The method may comprise selecting a vitamin component comprising one or more vitamins, wherein the one or more vitamins may be selected to have high active concentrations. The method may comprise selecting a mineral component comprising one or more minerals, wherein the one or more minerals may be selected to have high active concentrations. The method may comprise selecting a fruit and vegetable component comprising one or more fruits or vegetables. The method may comprise selecting a sweetening component comprising monk fruit. The method may comprise dry blending the vitamin component, the mineral component, the fruit and vegetable component, and the sweetening component to form the powdered beverage composition, wherein the powdered beverage composition

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

As used herein “about” may be understood to mean±/−15% and may account for, for example, variation in manufacturing processes.

In one or more exemplary embodiment a powdered beverage composition may be provided. The powdered beverage composition may comprise a vitamin component, a mineral component, a fruit component, a vegetable component, and a sweetening component. In some cases, the fruit component and the vegetable component may be combined as a single fruit and vegetable component. The powdered beverage composition may be designed for children, such as children of a particular age or age range, or for adults. For example, the powdered beverage composition may be designed for four-year-old kids, or the powdered beverage composition may be designed for toddlers.

The powdered beverage composition may be dissolvable in water or other liquids. In some cases, the powdered beverage composition may be configured to be soluble in cold or room-temperature water. In some cases, the powdered beverage composition may be configured to dissolve in water with stirring motion provided by a user.

The powdered beverage composition may be formulated to be flavorless, colorless, and odorless when dissolved in a beverage or soft food, such as yogurt or applesauce. Formulating the powdered beverage composition to be flavorless, colorless, and odorless may improve compliance by an intended subject at any age. Children may be reluctant to drink dissolved supplements because vitamins and minerals, particularly in concentrated form, may have a metallic taste. Additionally, supplements may discolor water and give water a gritty, unappetizing texture. By formulating the powdered beverage composition to be flavorless, colorless, and odorless, the powdered beverage composition may avoid these issues and improve acceptance by children and adults alike.

The sweetening component may mask the taste of vitamins, minerals, and nutrients in the powdered beverage composition. In some cases, monk fruit may be used as the sweetening component. The sweetening component may be introduced in a concentration sufficient to mask the taste of the vitamins, minerals, and nutrients but not provide a noticeable sweetness to the beverage.

The powdered beverage composition may have a bulk density less than 0.65 g/cm³. The bulk density of the powdered beverage composition may facilitate dissolution of the powdered beverage composition in a liquid or soft food.

The powdered beverage composition may be configured to be soluble in cold or room-temperature water. The powdered beverage composition may be configured to be dissolved in water with stirring motion provided by a drinker. In some cases, the powdered beverage composition may be dissolved with about 20 rotations at about 1 rotation per second. The stirring motion may be provided by hand using a utensil such as a fork or spoon.

The powdered beverage composition may be reconstituted in about 50-75 ml of cold water. In some cases, the cold water may be at about 45 to 55 degrees Fahrenheit. The reconstituted powdered beverage composition may have a clear appearance with no visible solute. The texture of the reconstituted powdered beverage composition may be smooth and not gritty.

The powdered beverage composition may also be dissolved in soft food. In some cases, the soft food may be yogurt or applesauce. Dissolving the powdered beverage composition in soft food may provide an alternative delivery method for subjects who may not wish to drink the powdered beverage composition dissolved in water.

The powdered beverage composition may be manufactured by blending the ingredients dry. Dry blending of the ingredients may allow for uniform distribution of the vitamin component, the mineral component, the fruit component, the vegetable component, and the sweetening component throughout the powdered beverage composition.

Manufacturing the powdered beverage composition may involve considerations related to the fine particle size of the powder. Fine powders may stick to manufacturing equipment, blow off a manufacturing line, or move with reduced flowability compared to granular materials such as table salt. Fine powders may not flow in a water-like manner but instead may slab off when shear stresses reach a limit, similar to how snow slab avalanches move. To address these manufacturing considerations, horizontal fill machines with short drops between manufacturing line components or packaging may be used. Using horizontal fill machines with short drops may reduce the spread of the fine powdered beverage composition during manufacturing. Using horizontal fill machines with short drops may also help avoid pluming, which occurs when fine powder recoils after falling and sends a small plume of material out.

Ingredients with higher active concentrations may be selected for the powdered beverage composition. Selecting ingredients with higher active concentrations may improve the dissolvability of the powdered beverage composition. Selecting ingredients with higher active concentrations may also minimize settling of particulates when the powdered beverage composition is dissolved in a liquid. For example, some versions of ingredients may be available in active ingredient concentrations of 0.1%, 1%, 10%, or 100%. Selecting ingredients with higher active concentrations may minimize the amount of powdered beverage composition required to deliver a desired amount of vitamins, minerals, or other nutrients, thereby improving the dissolvability of the powdered beverage composition in a given volume of liquid.

Smaller particle sizes may be used to improve the dissolvability of the powdered beverage composition. Using smaller particle sizes may allow the powdered beverage composition to dissolve more readily in a liquid or soft food. Using smaller particle sizes may also reduce the likelihood of visible particulates or a gritty texture in the reconstituted powdered beverage composition.

Ingredients may be selected that have little to no flavor or color when such ingredients are available. Selecting ingredients with little to no flavor may help maintain the flavorless character of the powdered beverage composition when dissolved. Selecting ingredients with little to no color may help maintain the colorless character of the powdered beverage composition when dissolved. By selecting ingredients with little to no flavor or color, the powdered beverage composition may avoid imparting undesirable taste or appearance to a beverage or soft food in which the powdered beverage composition is dissolved.

The powdered beverage composition may include a sweetening agent. In some cases, the sweetening agent may be monk fruit. Monk fruit may provide sweetening properties that mask undesirable tastes associated with vitamins, minerals, and nutrients in the powdered beverage composition.

The sweetening agent may be introduced in a concentration sufficient to mask the taste of vitamins, minerals, and nutrients in the powdered beverage composition. The concentration of the sweetening agent may be selected such that the sweetening agent does not provide a noticeable sweetness to the beverage when the powdered beverage composition is dissolved. By introducing the sweetening agent at a concentration that masks the taste of vitamins, minerals, and nutrients without providing noticeable sweetness, the powdered beverage composition may maintain a flavorless character when dissolved in a liquid or soft food.

Vitamins and minerals may have a metallic taste, particularly when present in concentrated form. Vitamin A, in particular, may have a strong metallic taste. The sweetening agent may counteract the metallic taste of vitamins and minerals in the powdered beverage composition. The sweetening agent may allow the powdered beverage composition to deliver vitamins, minerals, and nutrients without imparting an unpleasant taste to the beverage or soft food in which the powdered beverage composition is dissolved.

The concentration of the sweetening agent may be balanced to achieve taste masking without adding perceptible sweetness. In some cases, the concentration of the sweetening agent may be adjusted based on the amounts of vitamins, minerals, and nutrients in the powdered beverage composition. Different formulations of the powdered beverage composition, such as formulations for toddlers, kids, adult females, or adult males, may include different concentrations of the sweetening agent to achieve taste masking appropriate for the vitamin and mineral content of each formulation.

The vitamin component of the powdered beverage composition may include various vitamins delivered in specific forms. The delivery forms of the vitamins may be selected to provide bioavailability, stability, or solubility characteristics suitable for the powdered beverage composition.

Vitamin A may be delivered as retinyl palmitate. Retinyl palmitate is an ester of retinol (vitamin A) and palmitic acid. Delivering vitamin A as retinyl palmitate may provide a stable form of vitamin A for inclusion in the powdered beverage composition.

Vitamin C may be delivered as calcium ascorbate. Calcium ascorbate is a mineral salt of ascorbic acid. Delivering vitamin C as calcium ascorbate may provide a buffered form of vitamin C that may be less acidic than ascorbic acid.

Vitamin D may be delivered as VegD3® cholecalciferol or as vegan cholecalciferol. Cholecalciferol is also known as D3 (cholecalciferol). Delivering vitamin D as VegD3® cholecalciferol or vegan cholecalciferol may provide a plant-derived source of vitamin D3 suitable for vegetarian or vegan formulations of the powdered beverage composition.

Vitamin E may be delivered as d-alpha tocopherol succinate. D-alpha tocopherol succinate is an ester form of vitamin E. Delivering vitamin E as d-alpha tocopherol succinate may provide a stable form of vitamin E for inclusion in the powdered beverage composition.

Vitamin B1 (thiamin) may be delivered as thiamin. Delivering vitamin B1 as thiamin may provide a direct form of vitamin B1 for inclusion in the powdered beverage composition.

Vitamin B3 (niacin) may be delivered as niacinamide or niacin. Niacinamide, also known as nicotinamide, is an amide form of vitamin B3. Niacin, also known as nicotinic acid, is another form of vitamin B3. Delivering vitamin B3 as niacinamide or niacin may provide forms of vitamin B3 suitable for inclusion in the powdered beverage composition.

Vitamin B6 may be delivered as pyridoxine hydrochloride. Pyridoxine hydrochloride is a hydrochloride salt form of pyridoxine, which is one of the forms of vitamin B6. Delivering vitamin B6 as pyridoxine hydrochloride may provide a stable and water-soluble form of vitamin B6 for inclusion in the powdered beverage composition.

Vitamin B9 (folate) may be delivered as folate or L-5-methyltetrahydrofolate-calcium. L-5-methyltetrahydrofolate-calcium is a calcium salt of the active form of folate. Delivering vitamin B9 as folate or L-5-methyltetrahydrofolate-calcium may provide bioavailable forms of vitamin B9 for inclusion in the powdered beverage composition.

Vitamin B12 may be delivered as methylcobalamin. Methylcobalamin is a coenzyme form of vitamin B12. Delivering vitamin B12 as methylcobalamin may provide an active form of vitamin B12 for inclusion in the powdered beverage composition.

Vitamin B7 (biotin) may be delivered as biotin. Delivering vitamin B7 as biotin may provide a direct form of vitamin B7 for inclusion in the powdered beverage composition.

Vitamin B5 (pantothenic acid) may be delivered as pantothenic acid or d-calcium pantothenate. D-calcium pantothenate is a calcium salt of pantothenic acid. Delivering vitamin B5 as pantothenic acid or d-calcium pantothenate may provide forms of vitamin B5 suitable for inclusion in the powdered beverage composition.

Vitamin K2 (menaquinone) may be delivered as menaquinone-7. Menaquinone-7, also referred to as MK-7, is a form of vitamin K2. Delivering vitamin K2 as menaquinone-7 may provide a form of vitamin K2 with bioavailability characteristics suitable for inclusion in the powdered beverage composition.

The vitamin component of the powdered beverage composition may include vitamins in amounts suitable for kids. The amounts of vitamins in the vitamin component may be selected to provide appropriate nutritional supplementation for kids, such as children about four years old.

The amount of vitamin A in the powdered beverage composition for kids may be between about 200 mcg and 600 mcg. In some cases, the amount of vitamin A may be between about 250 mcg and 550 mcg. In some cases, the amount of vitamin A may be between about 300 mcg and 500 mcg. In some cases, the amount of vitamin A may be about 400 mcg.

The amount of vitamin C in the powdered beverage composition for kids may be between about 10 mg and 50 mg. In some cases, the amount of vitamin C may be between about 20 mg and 40 mg. In some cases, the amount of vitamin C may be between about 25 mg and 35 mg. In some cases, the amount of vitamin C may be about 30 mg.

The amount of vitamin D in the powdered beverage composition for kids may be between about 5 mcg and 35 mcg. In some cases, the amount of vitamin D may be between about 10 mcg and 30 mcg. In some cases, the amount of vitamin D may be between about 15 mcg and 25 mcg. In some cases, the amount of vitamin D may be about 20 mcg.

The amount of vitamin E in the powdered beverage composition for kids may be between about 4 mg and 30 mg. In some cases, the amount of vitamin E may be between about 6 mg and 20 mg. In some cases, the amount of vitamin E may be between about 8 mg and 15 mg. In some cases, the amount of vitamin E may be about 10 mg.

The amount of vitamin B1 in the powdered beverage composition for kids may be between about 0.5 mg and 2 mg. In some cases, the amount of vitamin B1 may be between about 0.7 mg and 1.5 mg. In some cases, the amount of vitamin B1 may be about 1 mg.

The amount of vitamin B3 in the powdered beverage composition for kids may be between about 1 mg and 10 mg. In some cases, the amount of vitamin B3 may be between about 2 mg and 8 mg. In some cases, the amount of vitamin B3 may be between about 4 mg and 7 mg. In some cases, the amount of vitamin B3 may be about 5 mg.

The amount of vitamin B6 in the powdered beverage composition for kids may be between about 0.5 mg and 2 mg. In some cases, the amount of vitamin B6 may be between about 0.7 mg and 1.5 mg. In some cases, the amount of vitamin B6 may be about 1 mg.

The amount of vitamin B9 in the powdered beverage composition for kids may be between about 50 mcg and 350 mcg. In some cases, the amount of vitamin B9 may be between about 100 mcg and 300 mcg. In some cases, the amount of vitamin B9 may be between about 150 mcg and 250 mcg. In some cases, the amount of vitamin B9 may be about 200 mcg.

The amount of vitamin B12 in the powdered beverage composition for kids may be between about 0.5 mcg and 3.5 mcg. In some cases, the amount of vitamin B12 may be between about 1 mcg and 3 mcg. In some cases, the amount of vitamin B12 may be between about 1.5 mcg and 2.5 mcg. In some cases, the amount of vitamin B12 may be about 2 mcg.

The amount of vitamin B7 in the powdered beverage composition for kids may be between about 5 mcg and 35 mcg. In some cases, the amount of vitamin B7 may be between about 8 mcg and 25 mcg. In some cases, the amount of vitamin B7 may be between about 9 mcg and 15 mcg. In some cases, the amount of vitamin B7 may be about 9.9 mcg.

The amount of vitamin B5 in the powdered beverage composition for kids may be between about 1 mg and 7 mg. In some cases, the amount of vitamin B5 may be between about 2 mg and 6 mg. In some cases, the amount of vitamin B5 may be between about 3 mg and 5 mg. In some cases, the amount of vitamin B5 may be about 4 mg.

The amount of vitamin K2 in the powdered beverage composition for kids may be between about 2 mcg and 8 mcg. In some cases, the amount of vitamin K2 may be between about 3 mcg and 7 mcg. In some cases, the amount of vitamin K2 may be between about 4 mcg and 6 mcg. In some cases, the amount of vitamin K2 may be about 5 mcg.

The vitamin component of the powdered beverage composition may include vitamins in amounts suitable for adults. The amounts of vitamins in the vitamin component may be selected to provide appropriate nutritional supplementation for adult females or adult males.

The amount of vitamin A in the powdered beverage composition for adult females may be between about 200 mcg and 500 mcg. In some cases, the amount of vitamin A for adult females may be between about 250 mcg and 450 mcg. In some cases, the amount of vitamin A for adult females may be between about 300 mcg and 400 mcg. In some cases, the amount of vitamin A for adult females may be about 350 mcg.

The amount of vitamin A in the powdered beverage composition for adult males may be between about 300 mcg and 600 mcg. In some cases, the amount of vitamin A for adult males may be between about 350 mcg and 550 mcg. In some cases, the amount of vitamin A for adult males may be between about 400 mcg and 500 mcg. In some cases, the amount of vitamin A for adult males may be about 450 mcg.

The amount of vitamin C in the powdered beverage composition for adults may be between about 50 mg and 150 mg. In some cases, the amount of vitamin C for adults may be between about 70 mg and 120 mg. In some cases, the amount of vitamin C for adults may be between about 80 mg and 100 mg. In some cases, the amount of vitamin C for adults may be about 90 mg.

The amount of vitamin D in the powdered beverage composition for adult females may be between about 50 mcg and 150 mcg. In some cases, the amount of vitamin D for adult females may be between about 70 mcg and 120 mcg. In some cases, the amount of vitamin D for adult females may be between about 80 mcg and 100 mcg. In some cases, the amount of vitamin D for adult females may be about 90 mcg.

The amount of vitamin E in the powdered beverage composition for adults may be between about 5 mg and 16 mg. In some cases, the amount of vitamin E for adults may be between about 7 mg and 14 mg. In some cases, the amount of vitamin E for adults may be between about 8 mg and 12 mg. In some cases, the amount of vitamin E for adults may be about 10 mg.

The amount of vitamin B1 in the powdered beverage composition for adults may be between about 0.6 mg and 2 mg. In some cases, the amount of vitamin B1 for adults may be between about 0.8 mg and 1.6 mg. In some cases, the amount of vitamin B1 for adults may be between about 1 mg and 1.4 mg. In some cases, the amount of vitamin B1 for adults may be about 1.2 mg.

The amount of vitamin B3 in the powdered beverage composition for adults may be between about 3 mg and 15 mg. In some cases, the amount of vitamin B3 for adults may be between about 5 mg and 10 mg. In some cases, the amount of vitamin B3 for adult females may be between about 6 mg and 8 mg, or about 7 mg. In some cases, the amount of vitamin B3 for adult males may be between about 6 mg and 9 mg, or about 8 mg.

The amount of vitamin B9 in the powdered beverage composition for adults may be between about 250 mcg and 550 mcg. In some cases, the amount of vitamin B9 for adults may be between about 300 mcg and 500 mcg. In some cases, the amount of vitamin B9 for adults may be between about 350 mcg and 450 mcg. In some cases, the amount of vitamin B9 for adults may be about 400 mcg.

The amount of vitamin B7 in the powdered beverage composition for adults may be between about 15 mcg and 45 mcg. In some cases, the amount of vitamin B7 for adults may be between about 20 mcg and 40 mcg. In some cases, the amount of vitamin B7 for adults may be between about 25 mcg and 35 mcg. In some cases, the amount of vitamin B7 for adults may be about 30 mcg.

The amount of vitamin B5 in the powdered beverage composition for adults may be between about 2 mg and 8 mg. In some cases, the amount of vitamin B5 for adults may be between about 3 mg and 7 mg. In some cases, the amount of vitamin B5 for adults may be between about 4 mg and 6 mg. In some cases, the amount of vitamin B5 for adults may be about 5 mg.

The amount of vitamin K2 in the powdered beverage composition for adults may be between about 10 mcg and 150 mcg. In some cases, the amount of vitamin K2 for adults may be between about 20 mcg and 100 mcg. In some cases, the amount of vitamin K2 for adults may be between about 40 mcg and 75 mcg. In some cases, the amount of vitamin K2 for adults may be about 50 mcg.

The mineral component of the powdered beverage composition may include various minerals delivered in specific forms. The delivery forms of the minerals may be selected to provide bioavailability, stability, or solubility characteristics suitable for the powdered beverage composition.

Iodine may be delivered as potassium iodide. Potassium iodide is an inorganic salt form of iodine. Delivering iodine as potassium iodide may provide a stable and water-soluble form of iodine for inclusion in the powdered beverage composition.

Zinc may be delivered as zinc citrate. Zinc citrate is a zinc salt of citric acid. Delivering zinc as zinc citrate may provide a form of zinc with solubility characteristics suitable for inclusion in the powdered beverage composition.

Selenium may be delivered as L-selenomethionine. L-selenomethionine is an amino acid form of selenium in which selenium replaces the sulfur atom in methionine. Delivering selenium as L-selenomethionine may provide an organic form of selenium for inclusion in the powdered beverage composition.

Manganese may be delivered as manganese citrate. Manganese citrate is a manganese salt of citric acid. In some cases, manganese may be delivered as TRAACS® Manganese Bisglycinate Chelate. TRAACS® Manganese Bisglycinate Chelate is a chelated form of manganese in which manganese is bound to two glycine molecules. Delivering manganese as manganese citrate or TRAACS® Manganese Bisglycinate Chelate may provide forms of manganese with bioavailability or solubility characteristics suitable for inclusion in the powdered beverage composition.

Chromium may be delivered as TRAACS® Chromium Nicotinate Glycinate Chelate. TRAACS® Chromium Nicotinate Glycinate Chelate is a chelated form of chromium. Delivering chromium as TRAACS® Chromium Nicotinate Glycinate Chelate may provide a form of chromium with bioavailability characteristics suitable for inclusion in the powdered beverage composition.

Molybdenum may be delivered as TRAACS® Molybdenum Glycinate Chelate. TRAACS® Molybdenum Glycinate Chelate is a chelated form of molybdenum in which molybdenum is bound to glycine. Delivering molybdenum as TRAACS® Molybdenum Glycinate Chelate may provide a form of molybdenum with bioavailability characteristics suitable for inclusion in the powdered beverage composition.

Iron may be delivered as iron carbonyl. Iron carbonyl, also referred to as carbonyl iron, is a form of elemental iron produced by decomposition of iron pentacarbonyl. Delivering iron as iron carbonyl may provide a form of iron suitable for inclusion in the powdered beverage composition. In some cases, iron may be included in formulations for adult females.

The mineral component of the powdered beverage composition may include minerals in amounts suitable for kids. The amounts of minerals in the mineral component may be selected to provide appropriate nutritional supplementation for kids, such as children about four years old.

The amount of iodine in the powdered beverage composition for kids may be between about 20 mcg and 150 mcg. In some cases, the amount of iodine may be between about 30 mcg and 100 mcg. In some cases, the amount of iodine may be between about 40 mcg and 75 mcg. In some cases, the amount of iodine may be about 50 mcg.

The amount of zinc in the powdered beverage composition for kids may be between about 2 mg and 8 mg. In some cases, the amount of zinc may be between about 3 mg and 7 mg. In some cases, the amount of zinc may be between about 4 mg and 6 mg. In some cases, the amount of zinc may be about 5 mg.

The amount of selenium in the powdered beverage composition for kids may be between about 1 mcg and 5 mcg. In some cases, the amount of selenium may be between about 2 mcg and 4.5 mcg. In some cases, the amount of selenium may be between about 2.5 mcg and 4 mcg. In some cases, the amount of selenium may be about 3 mcg.

The amount of manganese in the powdered beverage composition for kids may be between about 0.09 mg and 0.14 mg. In some cases, the amount of manganese may be between about 0.1 mg and 0.14 mg. In some cases, the amount of manganese may be between about 0.11 mg and 0.13 mg. In some cases, the amount of manganese may be about 0.12 mg.

The mineral component of the powdered beverage composition may include minerals in amounts suitable for adults. The amounts of minerals in the mineral component may be selected to provide appropriate nutritional supplementation for adult females or adult males.

The amount of iodine in the powdered beverage composition for adults may be between about 30 mcg and 150 mcg. In some cases, the amount of iodine for adults may be between about 40 mcg and 100 mcg. In some cases, the amount of iodine for adults may be between about 50 mcg and 70 mcg. In some cases, the amount of iodine for adults may be about 60 mcg.

The amount of zinc in the powdered beverage composition for adult females may be between about 1 mcg and 7 mcg. In some cases, the amount of zinc for adult females may be between about 2 mcg and 6 mcg. In some cases, the amount of zinc for adult females may be between about 3 mcg and 5 mcg. In some cases, the amount of zinc for adult females may be about 4 mcg.

The amount of zinc in the powdered beverage composition for adult males may be between about 3 mcg and 8 mcg. In some cases, the amount of zinc for adult males may be between about 4 mcg and 7 mcg. In some cases, the amount of zinc for adult males may be between about 5 mcg and 6 mcg. In some cases, the amount of zinc for adult males may be about 5.5 mcg.

The amount of selenium in the powdered beverage composition for adults may be between about 3 mcg and 9 mcg. In some cases, the amount of selenium for adults may be between about 4 mcg and 7.5 mcg. In some cases, the amount of selenium for adults may be between about 5 mcg and 6.5 mcg. In some cases, the amount of selenium for adults may be about 5.5 mcg.

The amount of manganese in the powdered beverage composition for adult females may be between about 0.12 mcg and 0.3 mcg. In some cases, the amount of manganese for adult females may be between about 0.14 mcg and 0.25 mcg. In some cases, the amount of manganese for adult females may be between about 0.16 mcg and 0.2 mcg. In some cases, the amount of manganese for adult females may be about 0.18 mcg.

The amount of manganese in the powdered beverage composition for adult males may be between about 0.16 mcg and 0.35 mcg. In some cases, the amount of manganese for adult males may be between about 0.18 mcg and 0.3 mcg. In some cases, the amount of manganese for adult males may be between about 0.2 mcg and 0.25 mcg. In some cases, the amount of manganese for adult males may be about 0.23 mcg.

The amount of chromium in the powdered beverage composition for adult females may be between about 1 mcg and 5 mcg. In some cases, the amount of chromium for adult females may be between about 1.5 mcg and 4 mcg. In some cases, the amount of chromium for adult females may be between about 2 mcg and 3 mcg. In some cases, the amount of chromium for adult females may be about 2.5 mcg.

The amount of chromium in the powdered beverage composition for adult males may be between about 1 mcg and 6 mcg. In some cases, the amount of chromium for adult males may be between about 2 mcg and 5 mcg. In some cases, the amount of chromium for adult males may be between about 3 mcg and 4 mcg. In some cases, the amount of chromium for adult males may be about 3.5 mcg.

The amount of molybdenum in the powdered beverage composition for adults may be between about 3 mcg and 6 mcg. In some cases, the amount of molybdenum for adults may be between about 3.5 mcg and 5.5 mcg. In some cases, the amount of molybdenum for adults may be between about 4 mcg and 5 mcg. In some cases, the amount of molybdenum for adults may be about 4.5 mcg.

The amount of iron in the powdered beverage composition for adult females may be between about 2 mg and 15 mg. In some cases, the amount of iron for adult females may be between about 6 mg and 12 mg. In some cases, the amount of iron for adult females may be between about 8 mg and 10 mg. In some cases, the amount of iron for adult females may be about 9 mg.

The mineral component of the powdered beverage composition may include a blend of calcium carbonate, choline bitartrate, and magnesium citrate. The blend of calcium carbonate, choline bitartrate, and magnesium citrate may be between about 1 mg and 5 mg. In some cases, the blend may be between about 1.5 mg and 4 mg. In some cases, the blend may be between about 2 mg and 3 mg. In some cases, the blend may be about 2.5 mg.

Adult formulations of the powdered beverage composition may include inositol in the mineral component. Inositol is a carbocyclic sugar that is structurally similar to glucose. Including inositol in the mineral component of adult formulations may provide additional nutritional supplementation for adult subjects.

Adult formulations of the powdered beverage composition may include a vitamin blend comprising inositol, calcium carbonate, choline bitartrate, and magnesium citrate. The vitamin blend for adult formulations may differ from the vitamin blend for toddler or kids formulations by including inositol in addition to calcium carbonate, choline bitartrate, and magnesium citrate.

The mineral component of the powdered beverage composition may include iron for adult female formulations. Iron may be included in adult female formulations to address nutritional supplementation considerations for adult females. As described above, iron may be delivered as iron carbonyl in the powdered beverage composition.

The mineral component of the powdered beverage composition may include chromium for adult formulations. Chromium may be included in adult formulations to provide nutritional supplementation for adult subjects. As described above, chromium may be delivered as TRAACS® Chromium Nicotinate Glycinate Chelate in the powdered beverage composition.

The mineral component of the powdered beverage composition may include molybdenum for adult formulations. Molybdenum may be included in adult formulations to provide nutritional supplementation for adult subjects. As described above, molybdenum may be delivered as TRAACS® Molybdenum Glycinate Chelate in the powdered beverage composition.

The powdered beverage composition may include a fruit and vegetable blend. The fruit and vegetable blend may comprise fruits and vegetables that provide additional vitamins, minerals, and nutrients to the powdered beverage composition. The fruit and vegetable blend may be between about 10 mg and 60 mg. In some cases, the fruit and vegetable blend may be between about 20 mg and 50 mg. In some cases, the fruit and vegetable blend may be between about 30 mg and 40 mg. In some cases, the fruit and vegetable blend may be about 34.5 mg.

Extracts of fruits or vegetables may be used in the fruit and vegetable blend. Using extracts of fruits or vegetables may provide concentrated forms of the nutrients present in the fruits or vegetables. In some cases, shiitake mushroom extract may be used in the fruit and vegetable blend. In some cases, acerola cherry extract may be used in the fruit and vegetable blend. Using extracts such as shiitake mushroom extract or acerola cherry extract may allow the powdered beverage composition to deliver nutrients from these sources in a form suitable for inclusion in the powdered beverage composition.

Each of the fruits or vegetables in the fruit and vegetable blend may be organic. Using organic fruits or vegetables in the fruit and vegetable blend may provide fruits and vegetables that have been grown according to organic agricultural practices. In some cases, the fruit and vegetable blend may include organic blueberry, organic strawberry, organic apple, organic elderberry, organic broccoli, organic cabbage, organic carrot, organic kale, organic parsley, organic raspberry, organic spinach, and organic tomato. In some cases, the fruit and vegetable blend may include cauliflower, acerola cherry extract, and shiitake mushroom extract in addition to organic fruits and vegetables.

The powdered beverage composition may be designed for children of a particular age or age range. In some cases, the powdered beverage composition may be designed for four-year-old children. In some cases, the powdered beverage composition may be designed for toddlers within a specified age range. The amounts of vitamins and minerals in the powdered beverage composition may be selected to provide appropriate nutritional supplementation for children of the particular age or age range for which the powdered beverage composition is designed.

The powdered beverage composition may be formulated for toddlers. A formulation for toddlers may use half the amounts of vitamins and minerals compared to kids formulations. By using half the amounts of vitamins and minerals in toddler formulations compared to kids formulations, the powdered beverage composition may provide nutritional supplementation appropriate for the nutritional requirements of toddlers.

The total weight of a single-serving formulation of the powdered beverage composition may be about 1 g for toddler formulations. The total weight of about 1 g for toddler formulations may include the vitamin component, the mineral component, the fruit and vegetable blend, and additional ingredients such as tapioca and monk fruit.

The total weight of a single-serving formulation of the powdered beverage composition may be about 1 g for adult formulations. The total weight of about 1 g for adult formulations may include the vitamin component, the mineral component, the fruit and vegetable blend, and additional ingredients such as tapioca and monk fruit. Adult formulations may include the same total weight as toddler formulations while providing different amounts of individual vitamins and minerals appropriate for adult nutritional supplementation.

The total weight of a single-serving formulation of the powdered beverage composition may be about 0.5 g for toddler formulations. The total weight of about 0.5 g for toddler formulations may correspond to the use of half the amounts of vitamins and minerals compared to kids formulations. The reduced total weight of toddler formulations may allow the powdered beverage composition to be dissolved in smaller volumes of liquid appropriate for toddler consumption.

The powdered beverage composition may be provided in single-serving packages. The single-serving packages may be designed to carry a sufficient amount of the powdered beverage composition to mix into a specified amount of a beverage. In some cases, the single-serving packages may contain about 1 g of the powdered beverage composition for toddler or adult formulations. In some cases, the single-serving packages may contain about 0.5 g of the powdered beverage composition for toddler formulations. The single-serving packages may be configured to allow a user to dispense the powdered beverage composition directly into a beverage or soft food for dissolution. The single-serving packages may be portable and may allow for convenient transport and storage of the powdered beverage composition. By providing the powdered beverage composition in single-serving packages, the powdered beverage composition may be dispensed in pre-measured amounts that correspond to the specified amount of beverage into which the powdered beverage composition is intended to be mixed.

The powdered beverage composition, upon reconstitution in a liquid such as water, may have a clear appearance with no visible solute. The clear appearance with no visible solute may result from the selection of ingredients with high active concentrations, the use of smaller particle sizes, and the formulation of the powdered beverage composition to dissolve within the solubility limit of the liquid. By selecting ingredients with higher active concentrations, the total amount of powdered beverage composition required to deliver the desired vitamins, minerals, and nutrients may be minimized, thereby reducing the likelihood that the powdered beverage composition will exceed the solubility limit of the liquid and leave visible particulates. The use of smaller particle sizes may allow the powdered beverage composition to dissolve more completely in the liquid, further contributing to the clear appearance with no visible solute.

The reconstituted powdered beverage composition may have a smooth texture that is not gritty. The smooth texture that is not gritty may result from the complete dissolution of the powdered beverage composition in the liquid. When the powdered beverage composition dissolves completely, no undissolved particulates remain to impart a gritty or sandy texture to the reconstituted composition. The selection of ingredients with high active concentrations and the use of smaller particle sizes may contribute to the complete dissolution of the powdered beverage composition and the resulting smooth texture. The formulation of the powdered beverage composition to have a bulk density less than 0.65 g/cm³ may also facilitate dissolution and contribute to the smooth texture of the reconstituted composition.

The reconstituted powdered beverage composition may be flavorless and odorless. The flavorless and odorless character of the reconstituted composition may result from the selection of ingredients that have little to no flavor or color, the use of the sweetening component to mask any residual taste from vitamins and minerals, and the formulation of the powdered beverage composition to avoid imparting taste or odor to the liquid. The sweetening component, such as monk fruit, may be introduced in a concentration sufficient to mask the metallic taste that vitamins and minerals may impart without providing a noticeable sweetness to the reconstituted composition. By selecting ingredients with little to no flavor and by using the sweetening component at an appropriate concentration, the powdered beverage composition may achieve a flavorless character when reconstituted.

The odorless character of the reconstituted powdered beverage composition may result from the selection of ingredients that do not impart odor to the liquid and from the formulation of the powdered beverage composition to avoid introducing odor-causing compounds. The selection of delivery forms for vitamins and minerals, such as retinyl palmitate for vitamin A, calcium ascorbate for vitamin C, and the various chelated forms for minerals, may contribute to the odorless character of the reconstituted composition by providing forms of vitamins and minerals that do not impart noticeable odor when dissolved.

The clear appearance, smooth texture, and flavorless and odorless character of the reconstituted powdered beverage composition may work together to provide a reconstituted composition that does not alter the sensory properties of the liquid or soft food in which the powdered beverage composition is dissolved. By achieving a clear appearance with no visible solute, a smooth texture that is not gritty, and a flavorless and odorless character, the reconstituted powdered beverage composition may be indistinguishable from the liquid or soft food prior to dissolution of the powdered beverage composition. The combination of these sensory properties may improve acceptance of the reconstituted composition by subjects, including children who may be reluctant to consume beverages or foods that have been visibly or perceptibly altered by the addition of supplements.

The formulation parameters of the powdered beverage composition, including the bulk density, the particle size, and the concentrations of the vitamin component, the mineral component, the fruit and vegetable blend, and the sweetening component, may be selected to achieve the clear appearance, smooth texture, and flavorless and odorless character of the reconstituted composition. The interrelationship of these formulation parameters may allow the powdered beverage composition to deliver vitamins, minerals, and nutrients while maintaining sensory properties that do not deter consumption by the intended subject.

The powdered beverage composition may have physical properties that are markedly different from the physical properties of the individual naturally occurring vitamin, mineral, fruit, and vegetable components. In some cases, the bulk density of the powdered beverage composition may be less than 0.65 g/cm³, which may be different from the bulk densities of the individual vitamin, mineral, fruit, and vegetable components in their naturally occurring states. The changed bulk density of the powdered beverage composition may result in dissolution characteristics that are not present in the individual naturally occurring components. The combination of the vitamin component, the mineral component, the fruit and vegetable component, and the sweetening component may result in a powdered beverage composition with physical properties that differ from the physical properties that would be expected from a simple mixture of the individual components.

The powdered beverage composition may have organoleptic properties that are markedly different from the organoleptic properties of the individual naturally occurring vitamin, mineral, fruit, and vegetable components. The individual vitamin and mineral components may have inherent taste characteristics, including metallic or bitter notes, that would be perceptible if the individual components were dissolved in water separately. The combination of the vitamin component, the mineral component, the fruit and vegetable component, and the sweetening component may result in a reconstituted composition that is flavorless, colorless, and odorless. The flavorless, colorless, and odorless character of the reconstituted composition may be different from the sum of the taste, color, and odor properties of the individual components. The sweetening component may interact with the vitamin component and the mineral component to mask the metallic taste of the vitamins and minerals in a synergistic manner, resulting in a reconstituted composition with organoleptic properties that are not predictable from the properties of the individual components alone.

The powdered beverage composition may have dissolution characteristics that are markedly different from the dissolution characteristics of the individual naturally occurring vitamin, mineral, fruit, and vegetable components. The individual vitamin and mineral components in their naturally occurring forms may have varying solubility characteristics, particle sizes, and dissolution rates. The combination of selecting ingredients with high active concentrations, using smaller particle sizes, and achieving a bulk density less than 0.65 g/cm³ may result in a powdered beverage composition that dissolves completely in small volumes of cold water without leaving visible particulates or imparting a gritty texture. The dissolution characteristics of the powdered beverage composition may be different from the dissolution characteristics that would be expected from a simple mixture of the individual naturally occurring components.

The combination of the vitamin component, the mineral component, the fruit and vegetable component, and the sweetening component may achieve results that are not predictable from the properties of the individual components. The specific combination of components in the powdered beverage composition may result in a reconstituted composition that is flavorless, colorless, and odorless while delivering vitamins, minerals, and nutrients from fruits and vegetables. The achievement of a flavorless, colorless, and odorless reconstituted composition while delivering the nutritional content of the vitamin component, the mineral component, and the fruit and vegetable component may not be predictable from the properties of the individual components, because the individual vitamin and mineral components may have inherent taste, color, and odor characteristics that would be expected to be perceptible in a reconstituted composition.

The powdered beverage composition may include tapioca. In some embodiments the tapioca may be, for example, tapioca dextrin and/or tapioca fiber. Tapioca Fiber may be used to increase the fiber content of the beverage composition. Tapioca may serve as a carrier or bulking agent in the powdered beverage composition. Tapioca may facilitate the uniform distribution of the vitamin component, the mineral component, the fruit and vegetable component, and the sweetening component throughout the powdered beverage composition. In some cases, tapioca may contribute to the dissolution characteristics of the powdered beverage composition by providing a matrix that disperses readily in water. Tapioca may also contribute to the flowability of the powdered beverage composition during manufacturing. The inclusion of tapioca in the powdered beverage composition may help maintain the flavorless, colorless, and odorless character of the reconstituted composition.

The manufacturing process of the powdered beverage composition may contribute to the markedly different characteristics of the final composition. Dry blending the vitamin component, the mineral component, the fruit and vegetable component, and the sweetening component may result in a uniform distribution of the components throughout the powdered beverage composition. The use of horizontal fill machines with short drops between manufacturing line components may preserve the fine particle size distribution of the powdered beverage composition and may contribute to the dissolution characteristics of the final composition. The manufacturing process may result in a powdered beverage composition with a bulk density less than 0.65 g/cm³ and with dissolution characteristics that are markedly different from the dissolution characteristics of the individual naturally occurring components.

### Example 1

A powdered beverage composition was prepared using the following formulation:

| Ingredient | Amount | |
|---|---|---|
| Vitamin A (as retinyl palmitate) | 400 | mcg RAE |
| Vitamin C (as calcium ascorbate & from broccoli) | 30 | mg |
| Vitamin D (as VegD3 ® cholecalciferol & from shiitake) | 20 | mcg |
| Vitamin E (as d-alpha tocopherol succinate & from shiitake) | 10 | mg |
| Thiamin (as Vitamin B1 & from cauliflower) | 1 | mg |
| Niacin (as niacinamide & from shiitake) | 5 | mg NE |
| Vitamin B6 (as pyridoxine hydrochloride & from shiitake) | 1 | mg |
| Folate (as L-5-methyltetrahydrofolate-calcium & from spinach) | 200 | mcg DFE |
| Vitamin B12 (as methylcobalamin & from shiitake) | 2 | mcg |
| Biotin (as biotin & from shiitake) | 9.9 | mcg |
| Pantothenic Acid (Vitamin B5)(as d-calcium pantothenate & from | 4 | mg |
| shiitake) | | |
| Iodine (as potassium iodide) | 50 | mcg |
| Zinc (as zinc citrate) | 5 | mg |
| Selenium (as L-selenomethionine) | 3 | mcg |
| Manganese (as manganese citrate) | 0.12 | mg |
| Vitamin K2 (as menaquinone-7) | 5 | mcg |
| Vitamin Blend (Calcium Carbonate, Choline Bitartrate, Magnesium | 2.5 | mg |
| Citrate) | | |
| Fruit & Vegetable Blend | 34.5 | mg |

(Organic Blueberry, Organic Strawberry, Acerola Cherry Extract,
Organic Apple, Cauliflower, Organic Elderberry, Organic Broccoli,
Organic Cabbage, Organic Carrot, Organic Kale, Organic Parsley,
Organic Raspberry, Organic Spinach, Organic Tomato, Shiitake
Mushroom Extract)

The ingredients were blended dry. The total weight of the single-serving formulation described above was about 1 g, which also included amounts of tapioca and monk fruit. The amounts above may be appropriate to achieve a large percentage daily value of the above for a kid.

The composition was reconstituted in about 50-75 ml of cold water (about 45 degrees and 55 degrees Fahrenheit) and was stirred with a fork by hand for about 20 rotations at about 1 rotation a second. The reconstituted composition had a clear appearance with no visible solute. The texture was smooth, not gritty. A panel of participants found the reconstituted composition to be flavorless and odorless.

### Example 2

A powdered beverage composition was prepared using the following formulation:

| Ingredient | Amount | |
|---|---|---|
| Vitamin A (as retinyl palmitate) | 200 | mcg RAE |
| Vitamin C (as calcium ascorbate & from broccoli) | 15 | mg |
| Vitamin D (as VegD3 ® cholecalciferol & from shiitake) | 10 | mcg |
| Vitamin E (as d-alpha tocopherol succinate & from shiitake) | 5 | mg |
| Thiamin (as Vitamin B1 & from cauliflower) | 0.5 | mg |
| Niacin (as niacinamide & from shiitake) | 2.5 | mg NE |
| Vitamin B6 (as pyridoxine hydrochloride & from shiitake) | 0.5 | mg |
| Folate (as L-5-methyltetrahydrofolate-calcium & from spinach) | 100 | mcg DFE |
| Vitamin B12 (as methylcobalamin & from shiitake) | 1 | mcg |
| Biotin (as biotin & from shiitake) | 4.95 | mcg |
| Pantothenic Acid (Vitamin B5) (as d-calcium pantothenate & from | 2 | mg |
| shiitake) | | |
| Iodine (as potassium iodide) | 25 | mcg |
| Zinc (as zinc citrate) | 2.5 | mg |
| Selenium (as L-selenomethionine) | 1.5 | mcg |
| Manganese (as manganese citrate) | 0.06 | mg |
| Vitamin K2 (as menaquinone-7) | 2.5 | mcg |
| Vitamin Blend (Calcium Carbonate, Choline Bitartrate, Magnesium | 1.2 | mg |
| Citrate) | | |
| Fruit & Vegetable Blend | 17.25 | mg |
| (Organic Blueberry, Organic Strawberry, Acerola Cherry Extract, | | |
| Organic Apple, Cauliflower, Organic Elderberry, Organic Broccoli, | | |
| Organic Cabbage, Organic Carrot, Organic Kale, Organic Parsley, | | |
| Organic Raspberry, Organic Spinach, Organic Tomato, Shiitake | | |
| Mushroom Extract) | | |

The ingredients were blended dry. The total weight of the single-serving formulation described above was about 0.5 g, which also included amounts of tapioca and monk fruit. The amounts above may be appropriate to achieve a large percentage of the minimum daily suggested amounts of the vitamins and minerals for a toddler.

The composition was reconstituted in about 50-75 ml of cold water (about 45 degrees and 55 degrees Fahrenheit) and was stirred with a fork by hand for about 20 rotations at about 1 rotation a second. The reconstituted composition had a clear appearance with no visible solute. The texture was smooth, not gritty. A panel of participants found the reconstituted composition to be flavorless and odorless.

### Example 3

A powdered beverage composition was prepared using the following formulation:

| Ingredient | Amount | |
|---|---|---|
| Vitamin A (as retinyl palmitate) | 350 | mcg RAE |
| Vitamin C (as calcium ascorbate & from broccoli) | 90 | mg |
| Vitamin D (as VegD3 ® cholecalciferol & from shiitake) | 20 | mcg |
| Vitamin E (as d-alpha tocopherol succinate & from shiitake) | 10 | mg |
| Thiamin (as Vitamin B1 & from cauliflower) | 1.2 | mg |
| Niacin (as niacinamide & from shiitake) | 7 | mg NE |
| Vitamin B6 (as pyridoxine hydrochloride & from shiitake) | 1.3 | mg |
| Folate (as L-5-methyltetrahydrofolate-calcium & from spinach) | 400 | mcg DFE |
| Vitamin B12 (as methylcobalamin & from shiitake) | 2.4 | mcg |
| Biotin (as biotin & from shiitake) | 30 | mcg |
| Pantothenic Acid (Vitamin B5) (as d-calcium pantothenate & from | 5 | mg |
| shiitake) | | |
| Iron (as iron carbonyl) | 9 | mg |
| Iodine (as potassium iodide) | 60 | mcg |
| Zinc (as zinc citrate) | 4 | mg |
| Selenium (as L-selenomethionine) | 5.5 | mcg |
| Manganese (as TRAACS © Manganese Bisglycinate Chelate) | 0.18 | mg |
| Chromium (as TRAACS © Chromium Nicotinate Glycinate | 2.5 | mcg |
| Chelate) | | |
| Molybdenum (as TRAACS © Molybdenum Glycinate Chelate) | 4.5 | mcg |
| Vitamin K2 (as menaquinone-7) | 50 | mcg |
| Vitamin Blend (Inositol, Calcium Carbonate, Choline Bitartrate, | 7.1 | mg |
| Magnesium Citrate) | | |
| Fruit & Vegetable Blend | 34.5 | mg |

(Organic Blueberry, Organic Strawberry, Acerola Cherry Extract,
Organic Apple, Cauliflower, Organic Elderberry, Organic Broccoli,
Organic Cabbage, Organic Carrot, Organic Kale, Organic Parsley,
Organic Raspberry, Organic Spinach, Organic Tomato, Shiitake
Mushroom Extract)

The ingredients were blended dry. The total weight of the single-serving formulation described above was about 1 g, which also included amounts of tapioca and monk fruit. The amounts above may be appropriate to achieve a large percentage of the minimum daily suggested amounts of the vitamins and minerals for an adult female.

The composition was reconstituted in about 50-75 ml of cold water (about 45 degrees and 55 degrees Fahrenheit) and was stirred with a fork by hand for about 20 rotations at about 1 rotation a second. The reconstituted composition had a clear appearance with no visible solute. The texture was smooth, not gritty. A panel of participants found the reconstituted composition to be flavorless and odorless.

### Example 4

A powdered beverage composition was prepared using the following formulation:

| Ingredient | Amount | |
|---|---|---|
| Vitamin A (as retinyl palmitate) | 450 | mcg RAE |
| Vitamin C (as calcium ascorbate & from broccoli) | 90 | mg |
| Vitamin D3 (as vegan cholecalciferol & from shiitake) | 20 | mcg |
| Vitamin E (as d-alpha tocopherol succinate & from shiitake) | 10 | mg |
| Thiamin (as Vitamin B1 & from cauliflower) | 1.2 | mg |
| Niacin (as niacinamide & from shiitake) | 8 | mg NE |
| Vitamin B6 (as pyridoxine hydrochloride & from shiitake) | 1.3 | mg |
| Folate (as L-5-methyltetrahydrofolate-calcium & from spinach) | 400 | mcg DFE |
| Vitamin B12 (as methylcobalamin & from shiitake) | 2.4 | mcg |
| Biotin (as biotin & from shiitake) | 30 | mcg |
| Pantothenic Acid (Vitamin B5) (as d-calcium pantothenate & from | 5 | mg |
| shiitake) | | |
| Iodine (as potassium iodide) | 60 | mcg |
| Zinc (as zinc citrate) | 5.5 | mg |
| Selenium (as L-selenomethionine) | 5.5 | mcg |
| Manganese (as TRAACS © Manganese Bisglycinate Chelate) | 0.23 | mg |
| Chromium (as TRAACS © Chromium Nicotinate Glycinate | 3.5 | mcg |
| Chelate) | | |
| Molybdenum (as TRAACS © Molybdenum Glycinate Chelate) | 4.5 | mcg |
| Vitamin K2 (as menaquinone-7) | 50 | mcg |
| Vitamin Blend (Inositol, Calcium Carbonate, Choline Bitartrate, | 7.1 | mg |
| Magnesium Citrate) | | |
| Fruit & Vegetable Blend | 34.5 | mg |
| (Organic Blueberry, Organic Strawberry, Acerola Cherry Extract, | | |
| Organic Apple, Cauliflower, Organic Elderberry, Organic Broccoli, | | |
| Organic Cabbage, Organic Carrot, Organic Kale, Organic Parsley, | | |
| Organic Raspberry, Organic Spinach, Organic Tomato, Shiitake | | |
| Mushroom Extract) | | |

The ingredients were blended dry. The total weight of the single-serving formulation described above was about 1 g, which also included amounts of tapioca and monk fruit. The amounts above may be appropriate to achieve a large percentage of the minimum daily suggested amounts of the vitamins and minerals for an adult male.

The composition was reconstituted in about 50-75 ml of cold water (about 45 degrees and 55 degrees Fahrenheit) and was stirred with a fork by hand for about 20 rotations at about 1 rotation a second. The reconstituted composition had a clear appearance with no visible solute. The texture was smooth, not gritty. A panel of participants found the reconstituted composition to be flavorless and odorless.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A powdered beverage composition, comprising:
a vitamin component comprising one or more vitamins selected from the group consisting of vitamin A, vitamin B1, vitamin B3, vitamin B5, vitamin B6, vitamin B7, vitamin B9, vitamin B12, vitamin C, vitamin D, vitamin E, and vitamin K2;
a mineral component comprising one or more minerals selected from the group consisting of iodine, zinc, selenium, manganese, calcium carbonate, choline bitartrate, and magnesium citrate;
a fruit and vegetable component comprising one or more of blueberry, strawberry, acerola cherry extract, tomato, apple, cauliflower, elderberry, broccoli, cabbage, carrot, kale, parsley, raspberry, spinach, and shiitake mushroom; and
a sweetening component comprising monk fruit.

2. The powdered beverage composition of claim 1, wherein the powdered beverage composition has a bulk density less than 0.65 g/cm³.

3. The powdered beverage composition of claim 1, further comprising tapioca.

4. The powered beverage composition of claim 1, wherein the mineral component further comprising inositol, iron, chromium, and molybdenum.

5. The powered beverage composition of claim 1, wherein the mineral component comprises a blend of calcium carbonate, choline bitartrate, and magnesium.

6. The powdered beverage composition of claim 1, wherein the vitamin component comprises one or more vitamins selected from the group consisting of vitamin A delivered as retinyl palmitate, vitamin B1 delivered as thiamin, vitamin B3 delivered as niacinamide, vitamin B5 delivered as d-calcium pantothenate, vitamin B6 delivered as pyridoxine hydrochloride, vitamin B7 delivered as biotin, vitamin B9 delivered as L-5-methyltetrahydrofolate-calcium, vitamin B12 delivered as methylcobalamin, vitamin C delivered as calcium ascorbate, vitamin D delivered as cholecalciferol, vitamin E delivered as d-alpha tocopherol succinate, and vitamin K2 delivered as menaquinone-7.

7. The powdered beverage composition of claim 1, wherein the mineral component comprises one or more minerals selected from the group consisting of iodine delivered as potassium iodide, zinc delivered as zinc citrate, selenium delivered as L-selenomethionine, and manganese delivered as manganese citrate.

8. The powdered beverage composition of claim 1, wherein the fruit and vegetable component comprises organic blueberry, organic strawberry, organic apple, organic elderberry, organic broccoli, organic cabbage, organic carrot, organic kale, organic parsley, organic raspberry, organic spinach, and organic tomato.

9. The powdered beverage composition of claim 1, wherein the fruit and vegetable component has a total mass of between about 10 mg and 60 mg.

10. The powdered beverage composition of claim 1, wherein the powdered beverage composition is configured to dissolve in water to form a reconstituted composition that is flavorless, colorless, and odorless.

11. The powdered beverage composition of claim 1, wherein the powdered beverage composition is configured to dissolve in about 50-75 ml of cold water, wherein the cold water is at about 45 to 55 degrees Fahrenheit.

12. The powdered beverage composition of claim 1, wherein the powdered beverage composition has a total weight of about 1 g per single serving.

13. The powdered beverage composition of claim 1, wherein the vitamin component comprises:
between about 200 mcg and 600 mcg of vitamin A;
between about 10 mg and 50 mg of vitamin C;
between about 5 mcg and 35 mcg of vitamin D;
between about 4 mg and 30 mg of vitamin E;
between about 0.5 mg and 2 mg of vitamin B1;
between about 1 mg and 10 mg of vitamin B3;
between about 0.5 mg and 2 mg of vitamin B6;
between about 50 mcg and 350 mcg of vitamin B9;
between about 0.5 mcg and 3.5 mcg of vitamin B12;
between about 5 mcg and 35 mcg of vitamin B7;
between about 1 mg and 7 mg of vitamin B5; and
between about 2 mcg and 8 mcg of vitamin K2.

14. The powdered beverage composition of claim 13, wherein the mineral component comprises:
between about 20 mcg and 150 mcg of iodine;
between about 2 mg and 8 mg of zinc;
between about 1 mcg and 5 mcg of selenium;
between about 0.09 mg and 0.14 mg of manganese; and
between about 1 mg and 5 mg of a blend comprising calcium carbonate, choline bitartrate, and magnesium citrate.

15. A method of manufacturing a powdered beverage composition, comprising:
selecting a vitamin component comprising one or more vitamins, wherein the one or more vitamins are selected to have high active concentrations;
selecting a mineral component comprising one or more minerals, wherein the one or more minerals are selected to have high active concentrations;
selecting a fruit and vegetable component comprising one or more fruits or vegetables;
selecting a sweetening component comprising monk fruit; and
dry blending the vitamin component, the mineral component, the fruit and vegetable component, and the sweetening component to form the powdered beverage composition, wherein the powdered beverage composition has a bulk density less than 0.65 g/cm³.

16. The method of claim 15, wherein selecting the vitamin component comprises selecting one or more vitamins from the group consisting of vitamin A, vitamin B1, vitamin B3, vitamin B5, vitamin B6, vitamin B7, vitamin B9, vitamin B12, vitamin C, vitamin D, vitamin E, and vitamin K2.

17. The method of claim 16, wherein selecting the mineral component comprises selecting one or more minerals from the group consisting of iodine, zinc, selenium, manganese, calcium carbonate, choline bitartrate, and magnesium citrate.

18. The method of claim 15, further comprising packaging the powdered beverage composition in single-serving packages, wherein each single-serving package contains about 1 g of the powdered beverage composition.

19. The method of claim 15, wherein dry blending the vitamin component, the mineral component, the fruit and vegetable component, and the sweetening component comprises using a horizontal fill machine with short drops between manufacturing line components to reduce spread of the powdered beverage composition during manufacturing.

20. The method of claim 19, wherein using the horizontal fill machine with short drops between manufacturing line components avoids pluming of the powdered beverage composition.
